(19) United States
(12) Patent Application Publication
(10) Pub. No.: US 2004/0087433 A1
(43) Pub. Date: May 6, 2004

(54) Synthetic aluminosilicates comprising a nepheline or carnegieite structure

(76) Inventor: Hans Herold, Montabaur (DE)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/240,489

(22) PCT Filed: Mar. 31, 2001
(86) PCT No.: PCT/EP01/03701

(30) Foreign Application Priority Data
Apr. 5, 2000 (DE) 100 16 884.1

(51) Int. Cl. C01B 33/26; B01J 29/04

(52) U.S. Cl. 502/60; 423/328.1

(57) ABSTRACT

The invention relates to synthetic aluminum silicates having a nepheline or carnegieite structure which have a thickening effect in aqueous systems of suspensions and solutions. The invention further relates to the preparation of such synthetic aluminum silicates and their use as thickeners and suspending and thixotropic agents for ceramic bodies, glazes and enamels. Finally, glaze and enamel slips, ceramic bodies, colors and pastes containing the above mentioned synthetic aluminum silicates are also provided.

### INTRODUCTION

The invention relates to synthetic aluminum silicates having a nepheline or carnegieite structure which have a thickening effect in aqueous systems of suspensions and solutions. The invention further relates to the preparation of such synthetic aluminum silicates and their use as thickeners and suspending and thixotropic agents for ceramic bodies, glazes and enamels. Finally, glaze and enamel slips, ceramic bodies, colors and pastes containing the above mentioned synthetic aluminum silicates are also provided.

### BACKGROUND OF THE INVENTION

There are several reasons for thickening aqueous systems of suspensions and solutions. For example, tooth pastes, cosmetic pastes, dish-washing detergents, aqueous inks and coatings, adhesives, glaze and enamel slips, cast or plastic ceramic bodies are applications which require a well-aimed control of the viscosity, shearing resistance and yield value. Enamel slip is an enamel paste prepared by wet-milling granulated enamel frit and other milling additives, such as quartz, feldspar, glass powder, clay and electrolytes. Frits are glassy, granulated or scaly glass batches produced by melting and subsequent chilling, in which water-soluble salts, such as soda or borax, are bound as silicates and thus converted to an essentially water-insoluble compound.

Clay and electrolytes are used to provide the slip with a coatable consistency. Rheological properties important to enamel application by dipping or spraying are the thixotropy and the yield value of the slip. When applied to a vertical, non-absorbent metal substrate, which may also have an enamel base coat, depending on the method employed, the slip must not sag or flow. Since the metallic substrate does not shrink upon drying, the enamel slip should have a low drying shrinkage in order to avoid the formation of drying cracks.

The dried enamel slip requires some degree of resistance against mechanical stress by vibration and abrasion so.that the workpiece can be processed further.

The short firing time of 3 to 7 minutes and the low firing temperature of 820 to 870° C. render the enamel batch sensitive to the presence of certain compounds.

Sulfates, chlorides, nitrates and carbonates are either dissolved in the glass flow, which results in surface defects in the enamel with sulfates and chlorides, or they cleave off gases at higher temperatures which may cause bubbles and craters in the enamel, as with carbonates.

A need for synthetic rheological thickeners is found for enamel, since clay, being a natural product, is subject to variations in chemical and mineralogical composition which exert an influence on the quality of the enamel. For example, low amounts of calcium carbonate in the clay already result in the above mentioned surface defects which are caused by degassing at high temperatures.

Further, clays are always contaminated by relevant proportions of more than 1% by weight of iron and titanium compounds. The enamel is colored yellowish or gray by these compounds, which reduces the maximum achievable whiteness of the enamel. Further, these Fe and Ti proportions render the batch sensitive to long dwelling times in the kiln during the firing process. Resistance to yellowing is decreased as the content of impurities containing iron and titanium increases.

The use of synthetic organic thickeners is limited by the shortness of the firing time and the high heating rate. Ideally, the degassing of all volatile components should be completed before the enamel batch has molten.

Inorganic synthetic thickeners are the highly swellable magnesium layer silicates as described in DE-A-41 17 323 and DE-A-16 67 502. Like the mixed metal hydroxides described, for example, in EP-A-0 207 811, they have not become established in the enamel technology as a substitute for clay. p Further, it is known that an Na zeolite A or P is converted to synthetic nepheline or carnegieite by calcination above 800° C. This process is generally known and also functions with the building blocks of a zeolite A, i.e., sodalites. M. Murat, C. R. Acad. Sc. Paris, Ser. C 272, 1392 (1971), describes the conversion of a zeolite 4A in the following way:

Zeolite 4A→amorphous carnegieite→crystalline carnegieite→crystalline nepheline

It may be added that crystalline nepheline undergoes transition to crystalline carnegieite at 130020 C.

U.S. 5,298,234 of Mizusawa Industrial Chemicals Ltd., Japan, describes an aluminum silicate having a cubic shape of the primary grain, a maximum size of 5 μm and an Al₂O₃ to SiO₂ molar ratio of from 1:1.8 to 1:5. The product is amorphous by X-ray diffraction and is said to have a BET surface area of lower than 100 m²/g. The product is obtained by treating zeolite 4A with acid at a minimum pH value of 5, followed by calcination above 300° C.

U.S. Pat. No. 5,961,943 describes a regularly shaped aluminum silicate for use as a miscible component in polymers and surface coatings which tends to have as low as possible adsorptive properties, in particular, a low hygroscopicity (i.e., a moisture adsorption of lower than 1%) and a low oil absorption (lower than 50 ml/100 g). It exhibits a high pigment volume concentration, a good dispersibility in resins and a refractive index which is similar to that of PVC. It is obtained by calcination of a synthetic A or P type zeolite and has a nepheline or carnegieite crystal structure. As further essential features of this aluminum silicate, a regular grain shape with an average particle size of 0.5 to 30 μm and with a narrow grain size distribution (D75/D25<3), a Mohs hardness of <6 and a BET specific surface area of at least 10 m²/g are stated. The low hygroscopicity of the aluminum silicates is achieved by reaction with stearic acid, which results in the aluminum silicate being coated with stearates. However, due to a relatively low calcination temperature and short treatment time, the aluminum silicates of U.S. Pat. No. 5,961,943 have a fairly high content of sodium aluminum silicate hydrates, which manifests itself in a loss on ignition at 1000° C. of 0.30% by weight or greater.

In U.S. Pat. No. 5,961,943, only an aqueous system with such aluminum silicates is described, namely, it is described that such aluminum silicates may serve as fillers of an artificial-resin bound coat for concrete.

Surprisingly, it has been found that special aluminum silicates which are obtained by complete calcination of zeolites above 900° C., followed by milling to a grain size of smaller than 4 μm, preferably to a grain size of smaller than 2.5 μm, are very good thickening agents. The aluminum silicates have a very low content of crystal water and a negative surface charge, which is compensated by mobile cations. Experimentally, it was found that about 0.1 mmol of NaOH/g of nepheline are dissolved and that a clearly measurable adsorptivity exists, which was determined according to the ammonium acetate method. Thus, nepheline can be referred to as an ion-exchanger.

Milling enlarges the colloid-chemically active (external) surface area on the grain boundary, which could be detected by determining the grain size distribution. The enlargement of this surface area showed a good correlation with the effectiveness of the nephelines according to the invention as suspending and thickening agents. The evaluations of Examples 7 and 8 by rotation viscometry (see also FIGS. 3 and 4) clearly show the increase of shearing tension and viscosity when the finer-grained nepheline N2 is used rather than N1. The mere addition of nepheline to the suspension at first has a liquefying effect due to NaOH which is dissolved. Only when suitable electrolytes are added, occupation of the effective surface with ions other than sodium is caused by an ion-exchange reaction. If these ions are Mg or Ca ions, for example, this causes a thinner electric double layer around the nepheline particles, and the latter are capable of forming skeleton or chain structures with each other. In this way, suspensions can be thickened and protected from phase separation for extended periods of time.

Due to their Theological properties, the synthetic aluminum silicates of this invention are suitable as stabilizers or thickeners for the above stated aqueous systems. Especially for enamel coatings and glazes, their low Fe and Ti contents and the absence of gas-releasing compounds (i.e., a low crystal content or low loss on ignition) are particularly advantageous as compared with natural clays. From natural multi-layered silicates or the synthetic multi-layered silicates of the above mentioned inventions, they are distinguished by a low swellability and a very low drying sensitivity. The Theological character of the suspensions thickened with the nephelines generally tends to structural viscosity rather than thixotropic behavior, and the water demand is lower, in principle, than in the use of layer silicates.

### SUMMARY OF THE INVENTION

Thus, the present invention relates to

(1) a synthetic aluminum silicate essentially having a carnegieite or nepheline structure and a grain size D50 of smaller than 4.0 μm;

(2) in a preferred embodiment of (1), the synthetic aluminum silicate has a specific surface area (BET) of smaller than 10 m²/g (if the grain shape is regular and approximately cubic or spherical) and/or a loss on ignition at 1000° C. of lower than 0.20% by weight; (3) a process for preparing the synthetic aluminum silicate defined in (1), comprising

(a) complete calcination of the starting zeolites at temperatures of greater than 900° C.; and

(b) milling of the calcined zeolites obtained in step (a) to grain sizes D50 of smaller than 4.0 μm;

(4) use of the synthetic aluminum silicate as defined in (1) or (2) as a thickener, suspending or thixotropic agent; and

(5) glaze or enamel slips, ceramic bodies, colors and pastes containing a synthetic aluminum silicate as defined in (1) or (2).

### DESCRIPTION OF THE FIGURES

FIGS. 1 and 2 show the grain size distribution of the milled nephelines N1 and N2 obtained in Examples 1 and 5

FIGS. 3 and 4 show the flow curves for Example 7 (for N1) and for Example 8 (for N2).

### DETAILED DESCRIPTION OF THE INVENTION

A “grain size D50 of smaller than 4.0 μm” according to the present invention means that 50% by weight of the particles have a particle size of smaller than 4.0 μm. Especially preferred are those aluminum silicates which have a grain size D75 of smaller than 4.0 μm.

“Aluminum silicates essentially having a carnegieite or nepheline structure” according to the invention comprise pure carnegieite and nepheline structures (when prepared from a pure Na zeolite) as well as aluminum silicates of the feldspar series additionally containing K, Ca, Mg and/or Ba ions (after a previous partial or complete ion-exchange of the starting Na zeolite).

According to the present invention, synthetic aluminum silicates having a carnegieite or nepheline structure are prepared from synthetic zeolites of type A or P (i.e., from Na zeolites, especially Na zeolite 4A). Alternatively, the synthetic aluminum silicates having a carnegieite or nepheline structure may also be prepared from synthetic zeolites of other types than type A or P, such as those belonging to the group of sheet and fibrous zeolites, such as heulandite, mordenite, erionite and offretite, and those zeolites which do not belong to the class of Na zeolites (e.g., zeolites whose cation is Ca, Mg, Ba and/or K).

Due to their skeleton structure, the synthetic aluminum silicates of the present invention have a negative surface charge compensated by mobile cations, and due to their large external surface area prepared by milling to grain sizes D50 of <4 μm, they exhibit properties as thickeners in aqueous systems of suspensions and solutions.

Due to the isomorphic replacement of SiO₄ tetrahedrons by AlO₄ tetrahedrons, the crystal of a synthetic zeolite exhibits negative surplus charges on its surface, which are compensated by cations. The cations are not rigidly incorporated in the crystal lattice, but are partially mobile and can be exchanged against other cations. Further, the crystal structures of zeolites exhibit cavities of different shapes. Cavities and mobile cations on the inner and outer surface provide the zeolite with the capability of replacing its own cations by other molecules. This is generally known and a precondition for the suitability of a zeolite as a molecular sieve.

It is known that zeolite A or P is converted to nepheline or carnegieite by calcination at between 800 and 1500° C.

However, “complete calcination” within the meaning of the present application requires that a calcination temperature of more than 90020 C. predominates in the whole reaction charge, i.e., for a time sufficient to enable the desired conversion to nepheline or carnegieite structure and release of the crystal water, so that the desired low crystal water content (i.e., low loss on ignition) of the aluminum silicate is achieved. The absolute time requirements depend on the absolute calcination temperature and on the water content and the type of the starting zeolite and is preferably at least 3 h, more preferably at least 6 h. The preferred calcination temperature is within a range of from 950 to 1250° C. Calcination can be effected in a chamber kiln, tunnel kiln, roller kiln or rotary kiln. During calcination, smaller and larger primary particles of the zeolite sinter into larger secondary particles. The zeolite loses its crystal structure and is converted to nepheline or carnegieite.

This conversion changes the α and β cells of the zeolites. The.water adsorptively bound within the cells is irreversibly expelled. Due to the removal of adsorptive and hydrate water, the nepheline obtains suitability, in principle, for use in ceramic glazes and bodies as well as enamel slips, e.g., as a substitute for natural nepheline.

When the calcined product is dispersed in water, it can be seen from the occurring increase of the pH value that not all the cations are firmly incorporated into the newly formed crystal. lattice. Part of these cations is freely mobile and can be exchanged. When the product is left in an agglomerated state, the pH value of a 5% suspension will increase to a value of about 9.0 to 11.0 in the course of a few days.

If the original grain size and grain size distribution of the primary grains are regenerated by milling the sintered product, it is found that the pH value of the solution increases to the above mentioned value within a few hours, but then no longer experiences any significant change. The above mentioned temporal change of the pH value corresponds to a behavior like that known from diffusion processes. It is to be considered that the source of the cations diffusing into the solution is not the.interior of the primary grain, i.e., the former α and β cells of zeolite A, but the surface of the primary grain.

The milling may be wet or dry, and milling in situ in admixture with other components may also be used. Wet milling increases the surface area of the sintered nepheline and solubilizes sodium ions adsorptively bound to the surface. With the thus activated nepheline and suitable electrolytes, solids/H₂O mixtures can be thickened.

The cation-exchange capacity (according to the ammonium acetate method) of the synthetic aluminum silicates of the present invention can be compared to that of the natural aluminum silicates having a one-layer mineral structure (kaolinitic clays).

Calcination followed by milling preferentially produces a synthetic aluminum silicate (nepheline/carnegieite) having the following properties:

1. A low content of Fe and Ti: Fe₂O₃<200 ppm, TiO₂<30 ppm.

2. A low content of gas-releasing compounds: loss on ignition at 1000° C.<0.1%.

3. A small grain size: D50 smaller than 4.0 μm (especially D75 smaller than 4 μm), preferably D50 smaller than 3.0 μm (especially D75 smaller than 3.0 μm), more preferably D50 smaller than 2.5 μm (especially D75 smaller than 2.5 μm), a typical grain size distribution being, for example, D25=1.4 μm, D50=2.3 μm, D75=3.7 μm, D100=10 μm.

4. A specific surface area within the range of the surface area theoretically determined from the grain size, preferably a surface area (BET) of greater than 1 m²/g, more preferably greater than 3 m²/g and smaller than 5 m²/g (a nepheline powder according to the invention with D75 of smaller than 3 μm theoretically has a specific surface area of 3.4 m²/g according to the BET method). A specific surface area as determined according to BET (DIN 66131/66132) of greater than 1 m²/g is found when regular grain shapes (cube for a material made from zeolite 4A and spherical shape for a nepheline prepared from a zeolite P) are present and the surface area achieved is within the range of that to be calculated theoretically. Such a calculation is possible only when the geometry of the bodies is known.

A cube having an edge length of 1 cm has a surface area of 6 cm². Cubes having edge lengths of 1 μm which together have a volume of 1 cm³ have a surface area of 6 m². Nepheline cubes with an edge length of 1 μm have thus a surface area of 2.31 m²/g at a density of 2.6 g/cm³ for nepheline (a split, columnar, platy, irregular nepheline powder broken by intensive milling of course eludes this approach).

5. A high negative surface charge: Cation exchange capacity of between 5 and 100 mval of NH₄⁺(according to the ammonium acetate method).

6. Chemical composition: at least 5 and preferably at least 10% by weight of Al₂O₃, for example, a composition containing 20% by weight of Na₂O, 35% by weight of Al₂O₃, 45% by weight of SiO₂.

7. pH value (100 g of nepheline in 50 g of H₂O): 12.0-13.0.

In addition, the synthetic aluminum silicate according to the invention exhibits “plastic” properties, i.e., it has a yield value and a plastic limit when an ion-exchange reaction was previously performed with electrolytes.

With the activated nepheline or carnegieite and suitable electrolytes, solids/H₂O mixtures can be thickened. Suitable electrolytes include salts of the mono- and divalent alkali and alkaline earth metals and their hydroxides, such as sodium, potassium, rubidium, cesium, magnesium, calcium, strontium, barium. As the acids required for salt formation, hydrochloric, sulfuric, nitric, silicic acids and aluminum hydroxide are preferred as inorganic components. Suitable organic acids include carboxylic acids, such as acetic and formic acids, and carbonic acid. Preferred electrolytes for applications in enamel technology are Na aluminate, K₂CO₃ and Mg acetate. For glazes, MgCl₂ is preferred.

The glaze and enamel slips, ceramic bodies, colors and pastes according to the present invention contain the usual ingredients known to the person skilled in the relevant art, and an amount of aluminum silicates according to the invention and electrolytes as necessary for adjusting the rheological properties of such composition. Preferred amounts of aluminum silicates and electrolytes are within a range of from 0.1 to 10, more preferably within a range of from 0.5 to 50% by weight of the dry mass. Thus, “ceramic bodies” refers to the inorganic powders after mixing and before shaping. Their composition is determined by the intended use and thus varies within broad limits. Classical ceramics mainly comprised mixtures of clays, quartz and feldspars, whereas today's oxide ceramics may contain up to 99.9% of an oxide, for example, Al₂O₃.

The invention further relates to the ceramic products and also the methods for their preparation. The process technology comprises the processing of inorganic powders, mixing and shaping them, drying and ceramic firing at above 800° C. in which the product obtains its final physical and chemical properties while sintering and melting phenomena are proceeding.

Further, the active surface areas of the powders according to the invention are a precondition for their suitability as supports for catalytically active substances if these require a negatively charged surface for their bonding to the substrate.

A pigment for powder-electrostatic enamel application can be prepared by subjecting the zeolite to ion-exchange with a coloring metal (e.g. Co using cobalt acetate), calcining it and thus firmly binding the Co within the host lattice. The pigment is subsequently milled and washed. Its surface is still negative and can be coated with the organic substances required for powder-electrostatic application (PVA, silicones).

The present invention is further illustrated by the following Examples, which do not, however, limit the scope of protection of the invention.

### EXAMPLES

### Example 1

Nepheline N1 is prepared by calcination of zeolite 4A (Zeoline S. A., Belgium) at temperatures of above 900° C. in an electric car-bottom kiln (Naber W 1000). The maximum firing temperature (Tₘₐₓ) was 1120° C., the holding time at Tₘₐₓ was 10 h. Zeolite 4A is stated to comprise 23% by weight Na₂O, 36% by weight Al₂O₃, 41% by weight SiO₂, based on the dry substance, and an average grain size of 2.7 μm. After wet milling on a centrifugal ball mill, the nepheline exhibits a pH value of 10.9 for a 5% suspension in water and a cation-exchange, capacity of 44 mval of NH₄⁺/100 g according to the ammonium acetate method, and a loss on ignition of 0.06% at an ignition temperature of 1000° C.

The specific surface area of this nepheline milled dry using 0.8% of the milling aid Aerosil 200 (specific surface area 200 m²/g) was determined according to BET (DIN 66131/66132) to be 3.5 m²/g, i.e., after subtraction of the surface area of the Aerosil, this yields a net value of 1.9 m²/g.

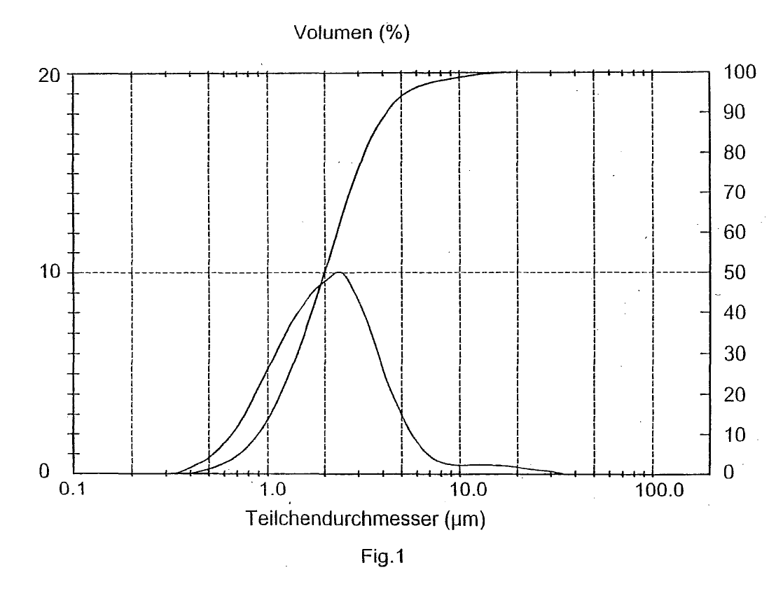

Grain size according to Mastersizer S long bed ver. 2.19: 0.87%<0.5 μm/12.79%<1.00 μm/30.79%<1.50 μm/47.66%<2.00 μm/62.07%<2.50 μm/73.18%<3.00 μm/73.18%<4.00 μm/92.13%<5.00 μm/94.81%<6.00 μm/100%<40 μm (see also FIG. 1). For a density of 2.6 g/cm³, the calculated surface area from this grain size distribution is 1.35 m²/g.

### Example 2

The following batch exhibits the rheological properties required for an enamel slip, the components being added in the stated order. Simple mixing is sufficient. Gel formation starts spontaneously after the addition of Mg acetate.

| Designation | Mass parts |
|---|---|
| Quartz powder W10 | 100 |
| Water | 37 |
| Nepheline N1 | 3 |
| Mg acetate | 0.2 |

Mg acetate can be replaced by the same amount of MgCl, Ca acetate or CaCl.

### Example 3

The following batch shows the chemical and physical properties required for a sanitary enamel.

| Designation | Mass parts |
|---|---|
| Enamel frit W 7309 | 100 |
| (boron titanium white frit | |
| supplied by Kaldewei) | |
| Water | 37 |
| Nepheline N1 | 3 |
| Mg acetate | 0.2 |

Addition of Mg acetate after wet milling of the frit and N1. Gel formation starts spontaneously then.

### Example 4

The following batch shows the chemical and physical properties required for a sanitary enamel.

| Designation | Mass parts |
|---|---|
| Enamel frit W 7308 | 100 |
| (boron titanium white frit | |
| supplied by Kaldewei) | |
| Water | 37 |
| Nepheline N1 | 3 |
| NaAlO₂ | 0.2 |
| K₂CO₃ | 0.2 |

Addition of all components prior to wet milling. Gel formation occurs in the course of several hours. A coatable consistency is reached after about 10 h.

### Example 5

A nepheline with the sample No. N2 is prepared by calcination in an electric chamber kiln (Naber N20/H) at above 900° C. from a zeolite P supplied by Crosfiled B. V., Netherlands. The maximum firing temperature (Tₘₐₓ) was 1000° C., the holding time at Tₘₐₓ was 4 h. This zeolite Zeocros CG-180 is stated to comprise 23/% by weight Na₂O, 35% by weight Al₂O₃, 42% by weight SiO₂, based on the dry substance, and an average grain size of smaller than 0.9 μm.

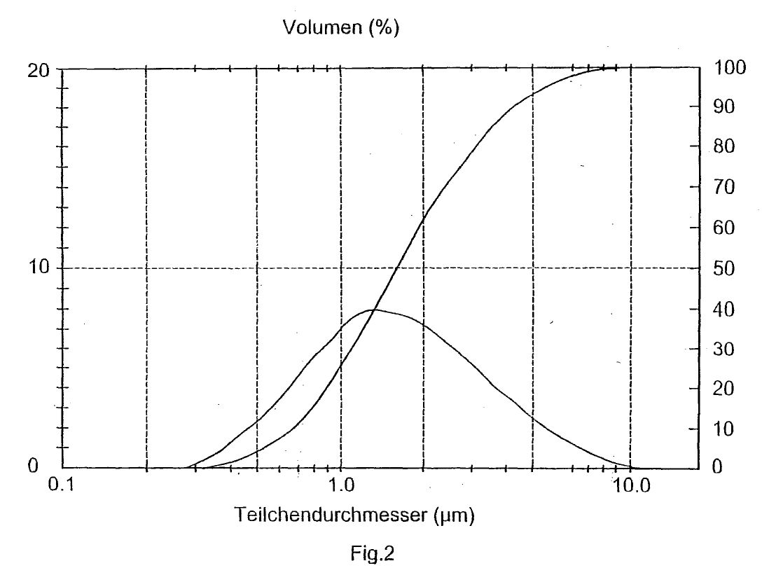

After wet milling on a centrifugal ball mill, the nepheline exhibits a pH value. of 11.3 for a 5% suspension in water, a BET value according to DIN 66131/66132 of 5.6 m²/g (after wet milling to 4.7% v/v <0.5 μm/26.2% <1.00 μm/46.42%<1.5 μm/60.95%<2.00 μm/71.15%<2.5 μm/78.41%<3 μm/83.53%<3.5 μm/87.17%<4 μm/91.82%<5 μm/94.57%<6 μm/100%<17 μm; determined with a Mastersizer S long bed ver. 2.19 (see also FIG. 2) and a loss on ignition of 0.08% at 1000° C.). For a density of 2.6 g/cm³, the calculated surface area from this grain size distribution is 1.8 m²/g.

### Example 6

Experiments 2 to 4 are repeated similarly with 2 mass parts of nepheline N2 instead of 3 mass parts of nepheline N1 and gave comparable results.

### Example 7

| Designation | Mass parts |
|---|---|
| Quartz powder W10 | 100.00 |
| Water | 38.00 |
| Nepheline N1 | 3.00 |
| Mg acetate | 0.20 |

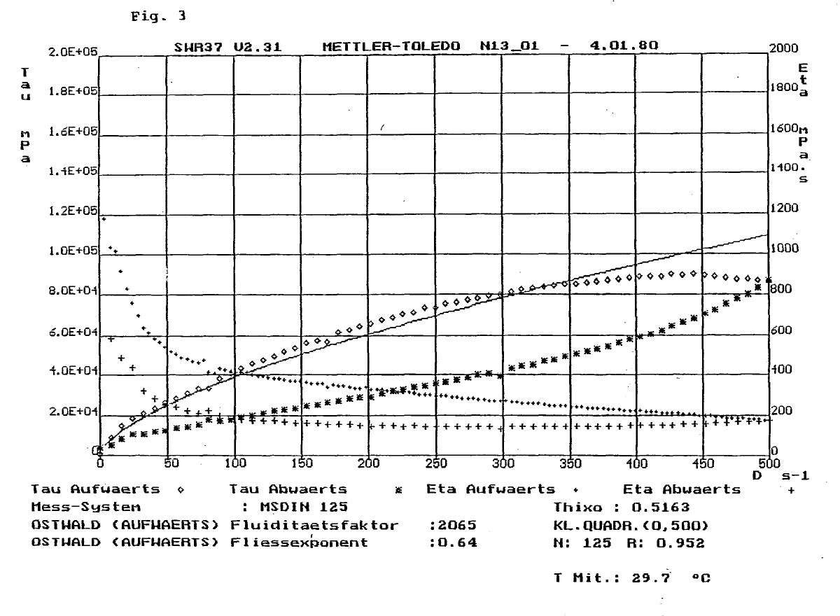

Addition of the components with constant mixing in the above order. The rotation viscometric evaluation (flow curve) is shown in FIG. 3.

### Example 8

| Designation | Mass parts |
|---|---|
| Quartz powder W10 | 100.00 |
| Water | 38.00 |
| Nepheline N2 | 3.00 |
| Mg acetate | 0.20 |

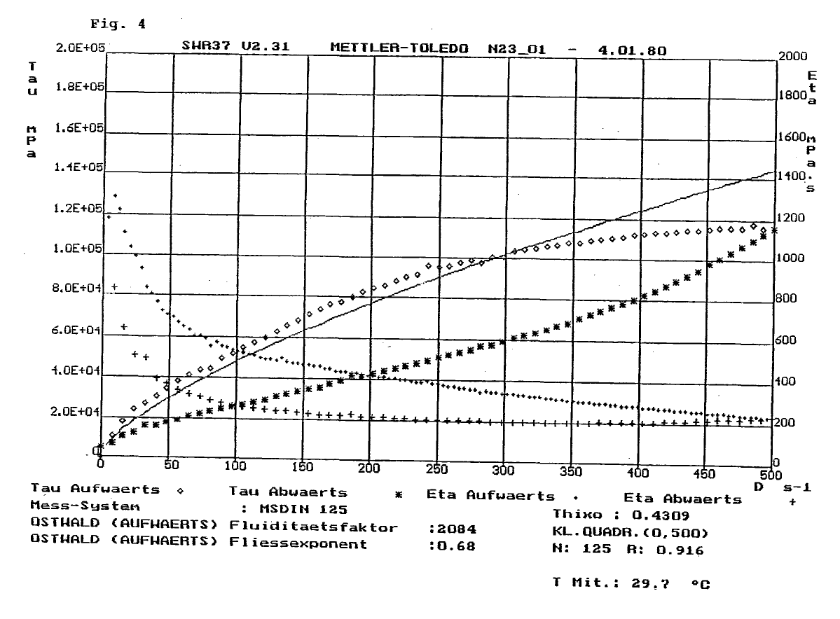

Addition of the components with constant mixing in the above order. The rotation viscometric evaluation (flow curve) is shown in FIG. 4.

1. A synthetic aluminum silicate essentially having a carnegieite or nepheline structure and a grain size D50 of smaller than 4.0 μm.

2. The synthetic aluminum silicate according to claim 1, having a regular grain shape and a specific surface area (BET) of smaller than 10 m²/g, preferably smaller than 5.0 m²/g.

3. The synthetic aluminum silicate according to claim 1 or 2, having a loss on ignition at 1000° C. of lower than 0.2% by weight, preferably lower than 0.1% by weight.

4. The synthetic aluminum silicate according to one or more of claims 1 to 3, exhibiting:
(a) a compensated negative surface charge;
(b) a specific surface area (BET) of greater than 1 m²/g;
(c) a grain size D50 of smaller than 3.0 μm, preferably D50 of smaller than 2.5 μm;
(d) a content of Fe₂O₃ of smaller than 200 ppm and a content of TiO₂ of smaller than 30 ppm; and/or
(e) an Al₂O₃ content of at least 5% by weight, preferably at least 10% by weight.

5. The synthetic aluminum silicate according to one or more of claims 1 to 4, which
(i) has a cubic or spherical microscopic appearance and can be obtained from synthetic zeolites of type A or P;
(ii) has a microscopic fibrous or sheet structure and can be obtained from zeolites having a fibrous or sheet structure, especially from heulandite, mordenite, erionite or offretite; or
(iii) can be obtained from zeolites which do not belong to the class of sodium zeolites.

6. The synthetic aluminum silicate according to claims 1 to 5, which has a cation-exchange capacity of between 5 and 100 mval NH₄⁺.

7. A process for preparing the synthetic aluminum silicate according to claims 1 to 6, comprising
(a) complete calcination of the starting zeolites at temperatures of greater than 900° C.; and
(b) milling of the calcined zeolites obtained in step (a) to grain sizes D50 of smaller than 4.0 μm.

8. The process according to claim 7, wherein said complete calcination is effected within a temperature range of greater than 900 to 1500° C., preferably within a temperature range of from 950° C. to 1250° C., and/or the duration of the calcination is at least 3 h, preferably at least 6 h.

9. The process according to claim 7 or 8, wherein said milling may be wet or dry.

10. The process according to claims 7 to 9, wherein said milling is effected with the synthetic aluminum silicates as a sole component, or in admixture with further materials.

11. Use of a synthetic aluminum silicate according to claims 1 to 6 as thickeners, suspending or thixotropic agents.

12. The use according to claim 11, wherein said synthetic aluminum silicate is employed as a suspending or thixotropic agent for ceramic bodies, glazes, enamels, colors and pastes.

13. The use according to claim 11 or 12, wherein said synthetic aluminum silicate is employed together with an electrolyte selected from alkali and alkaline earth metal salts, especially Mg acetate, MgCl₂, Na aluminate, K₂CO₃, Ca acetate and/or CaCl₂.

14. A glaze or enamel slip, ceramic body, color or paste containing a synthetic aluminum silicate according to claims 1 to 6.

15. A glaze or enamel slip, ceramic body, color or paste according to claim 14, further containing an electrolyte selected from alkali and alkaline earth metal salts, especially Mg acetate, MgCl₂, Na aluminate, K₂CO₃, Ca acetate and/or CaCl₂.
